(19) United States
(12) Patent Application Publication
(10) Pub. No.: US 2017/0344211 A1
(43) Pub. Date: Nov. 30, 2017

(54) Communication of a User Expression

(71) Applicant: Microsoft Technology Licensing, LLC, Redmond, WA (US)

(72) Inventor: Jason Thomas Faulkner, Seattle, WA (US)

(73) Assignee: Microsoft Technology Licensing, LLC, Redmond, WA (US)

(21) Appl. No.: 15/167,278

(22) Filed: May 27, 2016

(51) Int. Cl. G06F 3/0485; G06F 3/16

(52) U.S. Cl. CPC G06F 3/0485; G06F 3/167

(57) ABSTRACT

A method for communicating a user expression in a shared media event, such as a live videoconference. A user expression can be input by way of a graphic such as an emoticon or other symbol, and a time period is associated with the symbol or expression. The symbol is then displayed to other participants for the associated time period, while other real time media continues to be exchanged uninterrupted.

### TECHNICAL FIELD

The present disclosure relates to communication and collaboration over a network, and to enhancing communication over a network.

### BACKGROUND

Communication and collaboration are key aspects in people's lives, both socially and in business. Communication and collaboration tools have been developed with the aim of connecting people to share experiences. In many or most cases, the aim of these tools is to provide, over a network, an experience which mirrors real life interaction between individuals and groups of people. Interaction is typically provided by audio and/or visual elements.

Such tools include instant messaging, voice calls, video calls, group chat, shared desktop etc. Such tools can perform capture, manipulation, transmission and reproduction of audio and visual elements, and use various combinations of such elements in an attempt to provide a communication or collaboration environment which provides an intuitive and immersive user experience.

A user can access such tools at a user terminal which may be provided by a laptop or desktop computer, mobile phone, tablet, games console or system or other dedicated device for example. Such user terminal can be linked in a variety of possible network architectures, such as peer to peer architectures or client-server architectures or a hybrid, such as a centrally managed peer to peer architecture.

### SUMMARY

In many text based communication systems and environments, such as chat rooms and instant messaging, data exchanged between participants is associated with a particular time, and a communication environment displayed at a terminal or device typically represents a chronological display of messages or inputs. Previously sent or received messages or data are effectively static, and correspond to a fixed point in time, and users can scroll back and forth to see past or current messages.

In video or audio communication, data is usually exchanged in substantially real time, and a user typically only views or experiences live or current content. It is possible to record video or audio data for delayed playback, however the effect experienced by a viewer or listener is the same in that each frame of audio or video is heard or viewed only transiently.

It would be desirable to be able to provide increased functionality in live or real time communication such as audio or video communication. The ability to express ones point of view passively in the context of group engagement is part of normal social culture (shake hands, clap, smile, nod head, cheer, raise hand). Enabling users in virtual shared experiences to be empowered to express and engage to the group in alternative way to speaking and video is desirable to support natural conversation, collaboration and human connection.

According to a first aspect there is provided a method for communicating a user expression in a shared media event, said shared media event including one or more participants, the method comprising receiving an input representing at least one of a predefined set of user expressions, each said user expression being associated with a graphic object, said graphic object to be displayed at a user terminal of one or more participants of said shared media event; associating a time period with said at least one input expression, said time period controlling the duration of display of the associated object at a user terminal of said one or more participants of said shared media event; and sending to one or more participants of said shared media event, information representing said at least one graphic object and said time period

According to a related aspect there is provided a method for communicating a user expression in a shared media event, said shared media event including one or more participants, said method comprising receiving from one or more participants of said shared media event information representing at least one of a predefined set of user expressions, each said user expression being associated with a graphic object; associating a time period with said received information; and causing said one or more associated graphic objects to be displayed for a duration according to said time period.

In embodiments, the shared media event is live or progressed in real time, such as a live or pre-recorded video and/or audio conference or call, broadcast, live document collaboration or presentation for example. In this way, a symbol or visualisation of a user expression can quickly and easily be provided in a live or real time environment, which state can be expressed or displayed persistently for a designated time period. The visualisation or display of the user expression can be provided together with other media such as audio or video which continues to be exchanged and displayed in real time.

Information can therefore be exchanged and/or expressed passively without interrupting by audio means for example. This may offer particular advantage in a multi user real time environment, where there are often conflicting or competing audio inputs, and a communication system or environment may have difficulty in handling multiple simultaneous audio inputs.

A user expression can be input or designated substantially at one instant in time, at one participant terminal for example, and a corresponding graphic object can be displayed at one or more participant terminals over a duration. The graphic object can cease to be displayed without any further input from the user or participant inputting the user state. For example, in embodiments a user does not need to provide a separate input to turn “off” the user expression and/or corresponding graphic object, but may optionally choose to do so.

A user expression may be an expression of a personal user state or a user emotion or sentiment in embodiments, for example happiness, approval, confusion etc. A graphic object associated with such expressions may be an icon or symbol of a face with various expressions such as smiling or frowning, or hands performing various actions such as clapping for example. Graphic objects may be similar to so called emoticons or emojis used in text or chat based communication.

An expression of a communication state associated with participation in said shared media event may be considered. Such states may include a muted state, a voice only state, an away from terminal/desk state, a paused state etc. In embodiments these user “attribute” states are considered separately from “expression” as they signify a non-predetermined duration of modality state changed that is controlled by the user or user group

A graphic object may be static or may include movement, such as an animation.

The period of time or duration associated with a user state can be set by a user, or may be a default period set automatically by a user terminal or system or network apparatus. Time periods of approximately, 2 to 20 seconds or 5 to 10 seconds for example have been found to be preferable in embodiments. In the case of time periods being set by default, different user expressions may have different default time periods.

In aspects where information representing at least one of a predefined set of user expressions is received the time period associated with said received information may be received along with said information in embodiments, or may be determined on or after receipt of said information.

In embodiments where an input is received from a user representing a user expression, the graphic object associated with that expression may be displayed to the user. In this way the user can see or preview what is being or will be displayed at other participant terminals.

Methods above may be computer implemented, and a further aspect provides a non-transitory computer readable medium or computer program product, comprising computer readable instructions which when run on a computer or computer system, cause that computer or computer system to perform a method substantially as described above.

A yet further aspect provides an apparatus comprising a network interface adapted to communicate with at least one user terminal as part of a shared media event an input module adapted to receive an input representing at least one of a predefined set of user expressions, each said user expression being associated with a graphic object, said graphic object to be displayed at a user terminal of one or more participants of said shared media event; a processor adapted to associate a time period with said input expression, said time period controlling the duration of display of said object at a user terminal of said one or more participants of said shared media event; wherein said apparatus is adapted to send, to said at least one other user terminal via said network interface, information representing said graphic object and said time period.

A still further aspect provides an apparatus comprising a network interface adapted to communicate with at least one user terminal as part of a shared media event, and to receive from one or more participants of said shared media event information representing at least one of a predefined set of user expressions, each said user expression being associated with a graphic object, a processor adapted to associate a time period with said input, and a display adapted to display said one or more associated graphic objects for a duration according to said time period.

The invention extends to methods, apparatus and/or use substantially as herein described with reference to the accompanying drawings.

Any feature in one aspect of the invention may be applied to other aspects of the invention, in any appropriate combination. In particular, features of method aspects may be applied to apparatus aspects, and vice versa.

Furthermore, features implemented in hardware may generally be implemented in software, and vice versa. Any reference to software and hardware features herein should be construed accordingly.

### BRIEF DESCRIPTION OF THE DRAWINGS

Preferred features of the present invention will now be described, purely by way of example, with reference to the accompanying drawings, in which:

FIG. 1 illustrates schematically an example communications system;

FIG. 2 is a functional schematic of a user terminal;

FIG. 3 illustrates a menu to allow a user to input an expression;

FIG. 4 shows a display for a communication visualisation;

FIG. 5 shows an alternative display for a communication visualisation;

FIG. 6 shows another display for a communication visualisation.

### DETAILED DESCRIPTION OF EMBODIMENTS

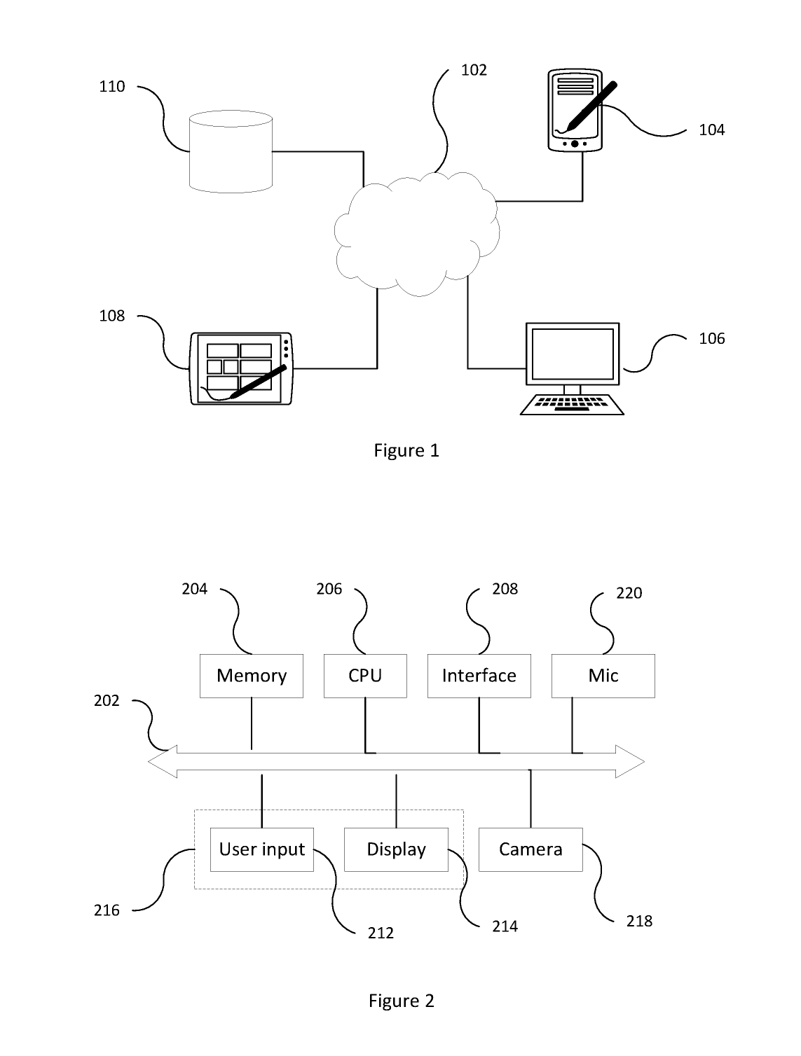

FIG. 1 illustrates an example of a communication system including example terminals and devices. A network 102 such as the internet or a mobile cellular network enables communication and data exchange between devices 104-110 which are connected to the network via wired or wireless connection. A wide variety of device types are possible, including a smartphone 104, a laptop or desktop computer 106, a tablet device 108 and a server 110. The server may in some cases act as a network manager device, controlling communication and data exchange between other devices on the network, however network management is not always necessary, such as for some peer to peer protocols.

A functional schematic of an example user terminal suitable for use in the communication system of FIG. 1 for example, is shown in FIG. 2.

A bus 202 connects components including a non-volatile memory 204, and a processor such as CPU 206. The bus 202 is also in communication with a network interface 208, which can provide outputs and receive inputs from an external network such as a mobile cellular network or the internet for example, suitable for communicating with other user terminals. Also connected to the bus is a user input module 212, which may comprise a pointing device such as a mouse or touchpad, and a display 214, such as an LCD or LED or OLED display panel. The display 214 and input module 212 can be integrated into a single device, such as a touchscreen, as indicated by dashed box 216. Programs such as communication or collaboration applications stored memory 204 for example can be executed by the CPU, and can cause an object to be rendered and output on the display 214. A user can interact with a displayed object, providing an input or inputs to module 212, which may be in the form of clicking or hovering over an object with a mouse for example, or tapping or swiping or otherwise interacting with the control device using a finger or fingers on a touchscreen. Such inputs can be recognized and processed by the CPU, to provide actions or outputs in response. Visual feedback may also be provided to the user, by updating an object or objects provided on the display 214, responsive to the user input(s). Optionally a camera 218 and a microphone 220 are also connected to the bus, for providing audio and video or still image data, typically of the user of the terminal.

User terminals such as that described with reference to FIG. 2 may be adapted to send media such as audio and/or visual data, over a network such as that illustrated in FIG. 1 using a variety of communications protocols/codecs, optionally in substantially real time. For example, audio may be streamed over a network using Real-time Transport Protocol, RTP (RFC 1889), which is an example of an end to end protocol for streaming media. Control data associated with media data may be formatted using Real time Transport Control Protocol, RTCP (RFC 3550). Sessions between different apparatuses and/or user terminals may be set up using a protocol such as Session Initiation Protocol, SIP.

A shared media event may comprise a voice call, video call, group chat, shared desktop, a presentation, live document collaboration, or a broadcast in embodiments. A shared media event may comprise two or more participants, and may typically comprise three or more or as many as 10, 50 or 100 participants or more.

A shared media event is typically live, and data provided by participants or participant's terminals, such as text, voice, video, gestures, annotations etc. can be transmitted to the other participants substantially in real time. A shared user event may however be asynchronous. That is, data or content provided by a user may be transmitted to other participants at a later time.

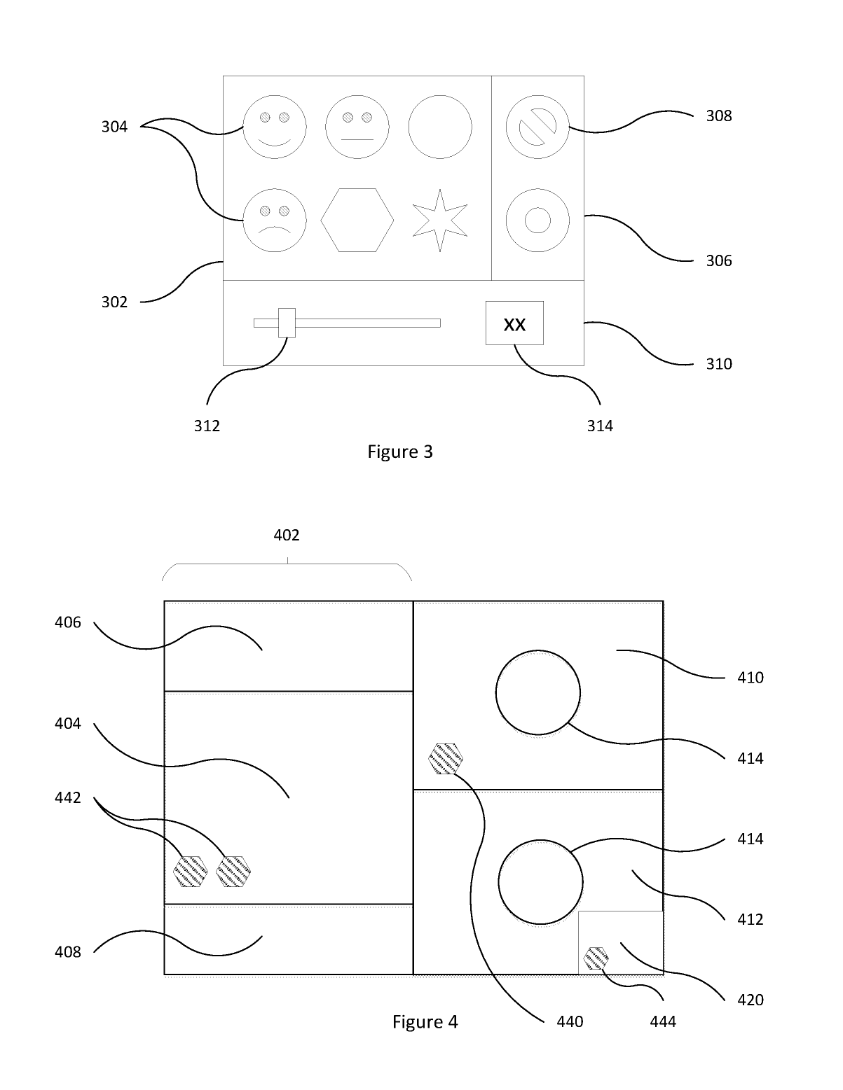

FIG. 3 shows a menu 302 which may be used by a participant of a shared media event to provide an input representing a user state. A plurality of predefined graphic objects such as symbols or icons 304 are displayed, each graphic object representing a user expression. User expressions may be personal expressions or feelings such as happiness or expressions of actions such as clapping or laughing. Expressions may also be of a state related to the shared media event, such as a state of being on mute for example. Here different faces are shown as examples, but any type of graphic object can be used, as represented by star hexagon and circle shapes. A user is able to select a symbol by tapping or clicking on it for example, using an input device such as 212 of FIG. 2. Menu 302 optionally also includes a section 306 containing icons or graphics 308 representing inputs which are not related to a user state, but instead relating to another aspect of the communication environment such as camera or audio settings for example.

An optional section of the menu 310 allows a user to input a time period. The time period is to be associated with a selected graphic object 304, and can be input via a slider bar 312 and/or a text input box 314 for example. A default time period may be set and displayed, and if a user does not change the default value or input a different time period, that default is associated with a symbol subsequently selected.

In embodiments where menu section 310 is not provided, a default time period is set for all symbols selected, or alternatively no time period is set, and a time period can be associated later, on reception at the terminal of another participant for example.

Before selecting a symbol, an enlarged preview of that symbol can be displayed, over or adjacent to the menu 302. Such a preview can be activated for example by hovering over a symbol with an input pointer, and a subsequent input such as clicking or double clicking acts to confirm the user input of that symbol.

Therefore, a menu can be provided for a user input representing one or a plurality of predefined user expressions, and optionally a time duration to be associated with said user state, which may be a dedicated menu, or may be appended to or combined with another menu.

FIG. 4 illustrates a display provided to a participant of a shared user event, in this case a video/audio call.

It can be seen that a display or screen is divided up into different areas or grid sections, each grid section representing a participant of the call. Here the grid is shown with rectangular cells which are adjacent, but the grid cells may be other shapes such as hexagonal or circular for example, and need not be regular or adjacent or contiguous. On the left hand side of the screen, area 402 is assigned to a participant, and a video stream provided by that user is displayed in area 404. It can be seen that area 404 does not fill the whole grid section 402. In order to preserve its aspect ratio, the video is maximised for width, and background portions 406 and 408 exist above and below the video.

The right hand side of the display is dived into two further rectangular grid sections. Each of these grid sections includes an identifier 414 to identify the participant or participants attributed to or represented by that grid section. The identifier may be a photo, avatar, graphic or other identifier, surrounded by a background area 410 in the case of the upper right grid section as viewed, comprising substantially the rest of grid section. In this case, the grid sections on the right hand side represent voice call participants, and these participants each provide an audio stream to the shared event.

A self view 420 is optionally provided in the lower right corner of the display to allow a user to view an image or video of themselves which is being, or is to be sent to other users, potentially as part of a shared media event such as a video call. The self view 420 sits on top of part of the background 412 of the lower right hand grid section.

A menu such as the menu 302 of FIG. 3 can be provided on or in association with the display of FIG. 4. The menu may be persistent in any given location, for example a corner of the display or in a floating window on top of the display. The menu may however be hidden, and ‘pop up’ on receiving a user input such as a keystroke or pointer action, such as hovering over a particular location such as the self view for example.

The display of FIG. 4 provides a visualisation environment of participants of a call, and audio and/or video is typically received from such participants. In addition, a user expression or expressions can be received, corresponding for example to user expressions selected by a menu 302 by other participants, and such expressions or representations thereof can be displayed. A graphic object or icon representing such a state is illustrated by shaded hexagon 440. The graphic object or icon is located at or adjacent the grid section representing the participant to which it relates or was input by. In this way it can be easily seen which expression (if any) corresponds to which participant. In this case, the graphic object is located in background area 410 corresponding to the participant represented by the top right grid section and identifier 414.

More than one graphic object can be displayed in relation to a single participant. Graphic objects 442 are both displayed in a display section 402 corresponding to a single user or user terminal, in this case superimposed on a video feed 404 of the respective participant.

An association is to the person or group expressing the visual symbol can be made by overlaying the expression on an avatar (photo, initials), name, video, content or symbol representing that person, group or content.

As well as displaying graphic objects associated with other participants, a graphic object 444 may be displayed on or adjacent to self view 420. This corresponds to an object or corresponding user expression selected by the viewer of the display of FIG. 4, to allow the viewer to see or preview what object or objects are being rendered, representing the selected or input expression of the viewer, on the displays of other participants.

Each graphic object has an associated time period or duration, set either by a sending or inputting participant or terminal, or by default, or by a receiving participant or terminal.

A graphic object is displayed substantially as soon as it is input by a participant, subject to transmission times and latency across a network. It is then displayed for the associated period of time, and cease to be displayed once that period of time has expired, unless it is re-sent, extended or renewed, as described below.

In an example therefore, a participant in an event such as a videoconference may like or agree with what another presenter is currently saying or showing. The user can bring up a menu such as menu and select an expression representing an agreement, such as a “thumbs up” symbol. Before sending the symbol may be previewed to the user, possibly to display any animation associated with the symbol, or to check that the symbol is as intended. The user then provides an input to send or submit the expression. Information representing the expression is sent to other participants, and where another participant has the sender represented on a display (for example as part of a display grid showing video from the sender, or an identifier for the sender for the purposes of identifying an audio based participant) the relevant symbol, which is the thumbs up symbol in this case is displayed on or adjacent to the representation. The symbol continues to be displayed while other audio or video may be ongoing, for the set duration, and after that duration expires, the symbol stops being displayed.

In embodiments, the display or representation of participants on a display can change, either automatically based on logic designed to prioritise or promote more active or relevant participants, or manually. Where a participant is displayed or represented together with a graphic object, and the position or method of display of that participant changes, the graphic object will “follow” the participant, to continue to be displayed in or adjacent to the display area associated with that participant.

By displaying a graphic object on the display of the participant that has input the object (a “self-view” object), that participant can be informed of the impending ‘expiry’ of that object, i.e. as the time period associated with that object is nearing expiry, and consequently the object will shortly cease to be displayed to other participants. This may be indicated by flashing or fading of the object for example. A participant may then provide an input to renew or extend the duration of the period, for example by clicking or tapping on the self-view object.

A participant may also cancel an object or expression which they have input, prior to expiry of the associated time period, for example with an input to a control on or associated with the self-view object.

For example, a participant may have input a thumbs up symbol to indicate approval of a particular speaker's current topic of conversation. A default display time or 20 seconds may have been used. If the speaker changes topic, or another speaker takes over, and the participant no longer agrees or approves of what is being said, then he or she can cancel the thumbs up expression before the 20 seconds has elapsed. This stops the symbol being displayed at other participant's terminals. He or she may then wish to express another symbol, such as a thumbs down for example.

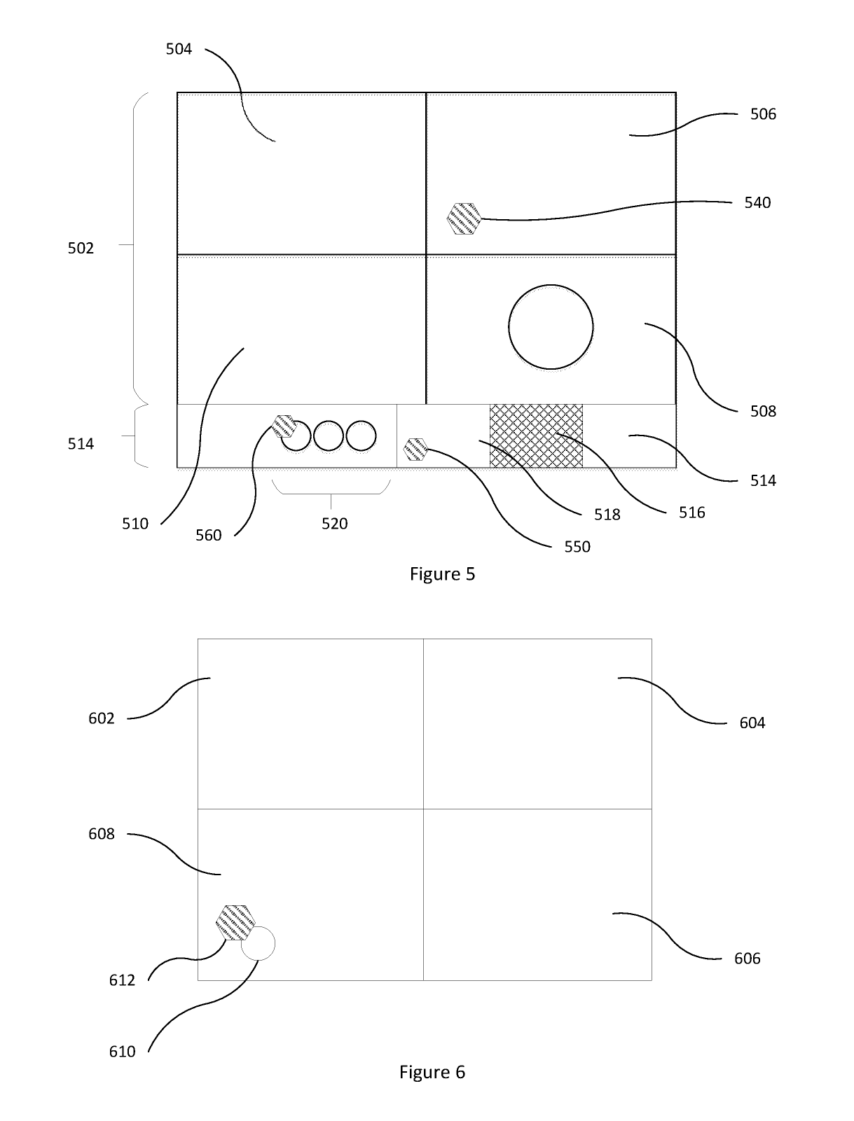

FIG. 5 illustrates another example of a display provided to a participant of a shared user event.

The display again includes various grid sections. Here a main or upper portion of the display 502 includes four grid sections 504, 506, 508 and 510. Grid sections 504, 506 and 510 each represent a participant to a call event, and display video of the respective participant. Grid section 508 represents a participant providing audio input only, and is represented with an identifier as described in relation to identifier 414 of FIG. 4. Lower portion 512 of the display is divided into three grid sections 514, 516 and 518 arranged to the right hand side. These grid sections can be used to represents participants and display video in a manner similar to the grid sections of the upper portion. The remaining part of the lower portion 512 on the left hand side is used to display identifiers 520 of one or more participants.

In the example of FIG. 5, grid section 516 is used to display content, such as a presentation for example, shown crosshatched. Content may include any document, work product, or written or graphic material which can be displayed as part of an event. Typical examples of content include a presentation or one or more slides of a presentation, a word processing document, or a spreadsheet document, a picture or illustration, or a shared desktop view. Multiple pieces of content, or multiple versions of a piece of content may be included in a given user event. In embodiments, content can be treated as a participant in terms of grid sections and display areas, and be displayed in place of a user video, or an identifier of a user.

In the example of FIG. 5, the different grid sections can be assigned to participants or content according to relative priorities. Grid sections in the upper portion 502 correspond to the most important, or highest priority participants or content, while grid sections 514, 516 and 518 correspond to lower priorities. Participants represented by identifiers 520 are lowest ranked in terms of priority, and in this example do not have corresponding video (if available) displayed.

In a similar manner to FIG. 4, a user expression or expressions can be received, input by other participants, and such expressions can be expressed or displayed. A graphic object or icon representing such an expression is illustrated by shaded hexagon 540 in grid section 506 corresponding to a certain participant. Graphic objects can similarly be displayed for participants viewed or represented in lower portion 514 of the display. For example, an expression of a participant represented by grid section 518 is displayed by object 550 in the bottom corner of the grid section. The state of a participant represented by one of the identifiers 520 is displayed by object 560 shown partially overlapping the relevant identifier.

In embodiments, it may be possible for a participant to address a user expression, such as applause for example, to only one or a selected group of participants, but not to all participants of the shared media event. FIG. 6 shows an example of a display including representations 602, 604, 606 and 608 of four participants in corresponding grid sections. In this example, all four participants are video participants, providing video feeds or streams which can be viewed. A fifth participant, called Alice for ease of reference, is initially not represented on the display, but inputs a user expression directed or addressed to the participant shown in grid section 608, called Bill for ease of reference. Alice's user expression can be indicated or displayed by a graphic object 612, however to differentiate from the case that the graphic originated from or is being expressed by Bill, the graphic object is accompanied by an identifier 610, which may be a photo, avatar, graphic or other identifier of Alice, in the same way as identifiers 414 and 520 of FIGS. 4 and 5 for example. In an example the expression may be agreement represented by a thumbs up icon. In this way, third party participants of the event can observe that Alice agrees with what is been said or shown by Bill, as opposed to what is being shown or said by any other participants.

It will be understood that the present invention has been described above purely by way of example, and modification of detail can be made within the scope of the claims. Each feature disclosed in the description, and (where appropriate) the claims and drawings may be provided independently or in any appropriate combination.

The various illustrative logical blocks, functional blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the function or functions described herein, optionally in combination with instructions stored in a memory or storage medium. A described processor may also be implemented as a combination of computing devices, e.g., a combination of a DSP and a microprocessor, or a plurality of microprocessors for example. Conversely, separately described functional blocks or modules may be integrated into a single processor. The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, and a CD-ROM.

1. A method for communicating a user expression in a shared media event, said shared media event including one or more participants, the method comprising:
receiving an input representing at least one of a predefined set of user expressions, each said user expression being associated with a graphic object, said graphic object to be displayed at a user terminal of one or more participants of said shared media event;
associating a time period with said at least one input expression, said time period controlling the duration of display of the associated object at a user terminal of said one or more participants of said shared media event; and
sending to one or more participants of said shared media event, information representing said at least one graphic object and said time period.

2. A method for communicating a user expression in a shared media event, said shared media event including one or more participants, said method comprising:
receiving from one or more participants of said shared media event information representing at least one of a predefined set of user expressions, each said user expression being associated with a graphic object,
associating a time period with said received information, and
causing said one or more associated graphic objects to be displayed for a duration according to said time period.

3. A method according to claim 1 or claim 2, wherein said shared media event is live or conducted in real time.

4. A method according to claim 1 or claim 2, wherein said shared media event is one of a video and/or audio call, a presentation, or a live or pre-recorded broadcast.

5. A method according to claim 1 or claim 2, wherein a user expression is an expression of a user emotion or sentiment.

6. A method according to claim 5, wherein said user expression is an expression of a communication state associated with participation in said shared media event.

7. A method according to claim 1 or claim 2, wherein said time period is a default time period.

8. A method according to claim 1 or claim 2, wherein said time period is a user defined time period.

9. A method according to claim 2, wherein the time period associated with said received information is a time period received with said information.

10. A method according to claim 2, wherein the time period associated with said received information is a time period determined on or after receipt of said information.

11. A method according to claim 1 or claim 2, wherein said user expression is addressed to one or more participants or content items of said shared media event.

12. A method according to claim 1 further comprising causing said at least one graphic object to be displayed to a participant who has provided an input corresponding to said graphic object.

13. A non-transitory computer readable medium comprising computer readable instructions which when run on a computer, cause that computer to perform operations including:
receiving an input representing at least one of a predefined set of user expressions, each said user expression being associated with a graphic object, said graphic object to be displayed at a user terminal of one or more participants of said shared media event;
associating a time period with said at least one input expression, said time period controlling the duration of display of the associated object at a user terminal of said one or more participants of said shared media event; and
sending to one or more participants of said shared media event, information representing said at least one graphic object and said time period.
